(19) United States
(12) Patent Application Publication
(10) Pub. No.: US 2011/0036839 A1
(43) Pub. Date: Feb. 17, 2011

(54) SCREW-CAPSULE FOR WINE BOTTLES

(76) Inventor: William A. Gardner, Napa, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 12/856,524

(22) Filed: Aug. 13, 2010

Related U.S. Application Data
(60) Provisional application No. 61/234,351, filed on Aug. 17, 2009.

(51) Int. Cl. B65D 41/34; B67B 3/20

(52) U.S. Cl. 220/266; 53/317; 53/490

(57) ABSTRACT

A plastic screw cap has a threaded top portion and tabs of varying heights disposed around an inner circumference of a lower sleeve-portion. These tabs clasp a land disposed on a container neck to restrain the sleeve portion on the neck when the cap is unscrewed. A threaded top portion mates with threads on the container above the land. A sealing liner and diffusion barrier disposed at the bottle opening, together with a crush-resistant cap structure, prevent wine leakage and control oxygen ingress. Typically, the plastic cap is threaded onto the container neck, forming a tamper-evident seal. When unscrewed, the plastic-cap top moves up the container threads, exerting a pull on the sleeve portion, which is restrained due to the closure tabs acting on the land. Between the closure tabs and the threaded top is a breakaway line, which tears due to the removal forces. This tear evidences tampering.

### CROSS-REFERENCE TO RELATED APPLICATIONS

This application claims priority from U.S. provisional application Ser. No. 61/234,351 filed on Aug. 17, 2009, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to sealing a container with a screw cap, and more particularly to sealing a wine bottle with a screw-type capsule.

2. Description of Related Art

Traditional wine bottle screw caps are aluminum. These metal screw caps have several drawbacks: they affect the taste of the wine they seal after a period of aluminum migration into the wine, making these screw caps ill-suited for storage or long-term aging of wines; they are easily deformed and deformation may compromise their sealing ability; they have a larger carbon footprint than is necessary for a screw cap; and the seal is not well protected against compromise from either top-loading-induced deformation of the screw-cap top or cap rotation in the counterclockwise direction that does not activate the tamper evidence feature.

There are several functional weaknesses and energy-consumption drawbacks of prior-art screw caps for wine bottles, some of which can degrade the bottle-sealing effectiveness of these closures and thereby spoil the wine and cause wine leakage.

An inherent weakness of metal screw caps for wine that is not consumed relatively soon after bottling is that wine is generally tainted by any contact with metal, and the metal in a screw cap does migrate over time through the standard seals presently in use with metal screw caps. This makes present-day metal screw caps inappropriate for long-term storage or aging of wine.

Another type of weakness is the rotational movement of screw caps that can occur despite the screw-cap locking mechanisms presently in use and without actuating the tamper evidence feature of these closures. This can compromise the seal without leaving any evidence. The compromised seal can substantially increase the oxygen transfer rate from the environment past the seal and into the wine. The resultant excessive oxidation of the wine spoils the wine. Also, if the bottle is not stored upright, the wine can leak out of the bottle.

Another weakness affecting wine quality and leakage is the susceptibility of the top portions of these closures to deformation (e.g., in the case of aluminum and plastic screw caps) or fracture (e.g., in the case of plastic screw caps) from: a) inadvertent impacts during shipping and handling, storage, retail-shelf stocking, consumer mishandling, and so on; or b) stacking of pallets of wine in wine-storage warehouses. This screw-cap damage can compromise the seal and thereby spoil the wine, and it can result in wine leakage. For example, aluminum screw caps presently in the market can be crushed in a stack of pallets that may be only ⅓ or ¼ the height of typical stacks for cork-sealed wine. With a nominal weight of 3 lbs for a bottle of wine, the usual industry practice (for wines sealed with corks) of stacking pallets as high as 30 cases (6 to 7 pallets, each 4 to 5 cases high) creates a nominal top loading of over 100 lbs (including pallet and cardboard box weight) on a screw cap. Present wine-industry practice for polymer screw caps is to not stack even two pallets of wine. Consequently, present industry practice is to not stack pallets of wine with screw caps of any type as high as present wine storage warehouses have been designed to accommodate. This expands the floor space requirements by factors ranging from 2 to 6. Given the energy consumption of these humidity- and temperature-controlled storage facilities, the carbon footprint of the overall packaging/storage of wine sealed with screw caps is substantially increased by this weakness.

A fourth weakness is the possible occurrence of axial motion of screw caps, due to top loading, which can compromise the seal and, thereby spoil the wine.

A fifth drawback is the impedance to glass-bottle recycling created by the aluminum material from the lower part of aluminum screw caps that is left on the bottle neck after opening. The difficulty of removing this aluminum material from the bottle neck results in these bottles being rejected for recycling during the initial screening process performed at glass recycling facilities. This substantially increases the carbon footprint of the overall wine package.

A sixth drawback of aluminum screw caps, which substantially increases the carbon footprint of the overall wine package, is the relatively high value of this green metric for aluminum screw caps relative to polymer screw caps. Polymers that are viable for fabricating screw caps for wine include 100% recyclable polyethylene terephthalate (PET) and even 100% recycled PET. The reduction in the carbon footprint of a PET screw cap, relative to the aluminum screw cap, is estimated to be about a factor of 3.

A seventh drawback of aluminum screw caps is their incompatibility with PET bottles, resulting from the roll-on installation of the screw cap on the bottle during which the threads in the screw cap are formed. PET bottles are now being considered by the industry for bottling wine. A polymer screw cap married with a PET wine bottle would be another step toward minimizing the carbon footprint of wine packaging.

An eighth drawback is the personal injury that presently occurs from opening bottles with aluminum screw caps. These injuries occur in the form of cut fingers and hands resulting from contact with sharp edges that exist at the bottom edge of the screw cap after it breaks away from the portion that remains on the neck of the bottle.

### BRIEF SUMMARY OF THE INVENTION

The present invention generally comprises a capsule for a wine bottle that can be screwed onto, and off of, the wine bottle. The capsule improves the functionality of, and reduces the energy consumption associated with, screw-cap closures for wine bottles by reducing or removing the various weaknesses and drawbacks of prior-art screw caps.

In various embodiments, an apparatus for sealing a container according to the invention comprises a molded plastic screw-capsule having means for sealing a liquid within a container of the type having a threaded region adjacent its opening. Preferably, the plastic screw-capsule has the appearance of a traditional foil wrap over a traditional wine bottle top without threads when it is on the container and in the sealed position.

The screw-capsule may comprise a threaded sleeve portion with an unthreaded top portion, or an unthreaded sleeve portion with a threaded top portion, or a threaded sleeve portion with a threaded top portion. The screw-capsule may comprise a single member or separate sleeve and top members attached to each other.

In various embodiments, the threads may be integrated into the sleeve or top portions, or can be provided by a separate threaded insert.

In one embodiment, the means for sealing may comprise a liner that, when the capsule is on the container and in the sealed position, would be disposed between the underside of the top of the capsule assembly and the rim at the top of the container. The purpose of this liner may be to obtain a reliable seal against wine leakage or to control the oxygen transfer rate into the container.

In one embodiment, the screw-capsule may include a “breakaway” or “separation” line. This line need not be linear, and need not be contiguous, but rather denotes a region where a single part can be separated into two sub-parts.

In one embodiment, the means for sealing may comprise closure tabs with graduated heights interior to the capsule that mate with a bottle neck land disposed about the opening in the container. This bottle neck land may be disposed below the threads on the bottle neck. In one embodiment, a breakaway line in the capsule serves to allow for separation of a threaded capsule top from a capsule sleeve that has closure tabs to clasp the land on the container neck. The separation at the breakaway line may require no additional tool or element. In fact, this is generally accomplished simply by hand twisting the capsule.

In one embodiment, the means for sealing may comprise a thickened annular region (the region between two concentric circles)disposed on the top of the capsule that compresses axially against the top of the container to form a seal. The thickened annular region serves to distribute axial loadings in a manner that is uniform around the rim of the bottle and also in a manner that emphasizes transfer of the loadings to the lower portion of the capsule where they can be further transferred to the threads on the container so as to avoid over-compression of the sealing liner and reduce deformation or otherwise reduce yielding or cracking of the top portion of the plastic screw-capsule, thereby allowing for higher pallet stacking levels and also reducing the occurrence of compromised seals. Over compression here means any compression beyond the desired level set when the screw-capsule is applied to the bottle on the wine bottling line.

In one embodiment, the means for sealing may comprise a thickened circumferential region disposed adjacent to the threads in the capsule that compresses axially against the threads on the container. The thickened circumferential region serves to distribute axial loadings in a manner that is uniform around the threads in the capsule and the container and also in a manner that emphasizes transfer of the loadings from the capsule top to the threads on the container so as to avoid over-compression of the sealing liner and reduce deformation or otherwise reduce yielding or cracking of the top portion of the plastic screw-capsule, thereby allowing for higher pallet stacking levels and also reducing the occurrence of compromised seals. Over compression here means any compression beyond the desired level set when the screw-capsule is applied to the bottle on the wine bottling line.

In one embodiment, the means for sealing may contain both the thickened annular and circumferential regions described above.

In one embodiment, the means for sealing may comprise one or more closure tabs disposed about an inner circumference of the capsule. These closure tabs may extend for a set of graduated heights above an inner circumference line of the screw-capsule. These heights are measured coaxially with the axis of the inner circumference. The purpose of the closure tabs is to engage one or more lands adjacent to the container opening. Thereby, the screw-capsule is locked in place once it is twisted onto the bottle, and also the lower section of the screw-capsule with the closure tabs stays behind, below the breakaway line, when the capsule top is twisted off upon opening.

In another embodiment of the invention, a method of sealing and unsealing a container may comprise providing a screw-capsule, where the capsule comprises one or more closure tabs of graduated heights disposed about an inner circumference; a breakaway line disposed between the closure tabs and a capsule top; and one or more threads disposed on a side opposite the breakaway line from the closure tabs; providing a container with an opening, wherein a thread and a land are disposed about the opening, with the thread closer to the opening than the land; twisting the screw-capsule onto the container with the opening, wherein at least one of the closure tabs flexes over the land while the thread on the container is engaged with the thread in the screw-capsule; thereby sealing the container. After each of the graduated-height closure tabs successively flexes over the land, it snaps underneath the edge of the land furthest from the bottle top, and provides a bearing surface for the closure tab to press against when the screw-capsule is unscrewed.

The unsealing step may comprise applying a twist to the capsule opposite in direction from the sealing twist discussed above, thereby translating the capsule back up the container thread while restraining at least one of the closure tabs on a lower section against the land, thereby creating a tensile force sufficient to tear the breakaway line and thereby separate the capsule into the lower section with the closure tabs, and an upper section with the threads of the-screw-capsule.

After unsealing, one may practice viewing the torn breakaway line as an indication of tampering. In this way, it is known whether product sealed within the screw-capsule has been tampered with in some way.

In still another embodiment of the invention, an improved container and sealing system may comprise a container having an externally threaded neck and a land disposed further from a neck opening; and a screw-capsule, the capsule comprising: a sleeve portion comprising one or more closure tabs; a threaded top portion comprising an internally threaded sleeve, that mates with and seals to the externally threaded neck; and a breakaway line disposed between the sleeve portion and the threaded top portion.

The screw-capsule composition may be selected from a group of thermoplastics consisting essentially of: polyethylene (PE) of all densities (LDPE to HDPE), polyethylene terephthalate (PET), recycled polyethylene terephthalate, cross-linked polyethylene (PET), polyphenyl ether (PPE), polyvinyl chloride (PVC), polyvinylidene chloride (PVDC), polylactic acid (PLA), polypropylene (PP), polybutylene (PB), polybutylene terephthalate (PBT), polyamide (PA), polyimide (PI), polycarbonate (PC), polytetrafluoroethylene (PTFE), polystyrene (PS), polyurethane (PU), polyester (PEs), acrylonitrile butadiene styrene (ABS), polymethyl methacrylate (PMMA), polyoxymethylene (POM), polysulfone (PES), styrene-acrylonitrile (SAN), ethylene vinyl acetate (EVA), styrene maleic anhydride (SMA), one or more of the foregoing, and glass or other insoluble structural fiber filling mixed in with the foregoing.

In various embodiments an oxygen transfer rate limiter may be disposed between the neck opening and the capsule top, wherein oxidation rate of any contents of the container is limited thereby. Further, between the oxygen transfer rate limiter and the capsule top, or between the neck opening and the oxygen transfer rate limiter, there may be a compliant seal, whereby the contents of the bottle are sealed by the plastic cap.

In the various embodiments employing graduated height closure tabs, as a capsule is threaded down onto the bottle and nears its terminal position, the tabs with the lowest heights begin to snap in place under the bottom ledge of the glass band. Depending on the actual axial positions of the features described above, the capsule will reach its final lock-on position with one or more of the closure tabs in each group snapped in place under the glass ledge. The range of graduations and the size of the height increments in graduation determine the number and widths of the tabs. The range is determined by the tolerances on the glass and capsule, and the increment size is determined by the desired upper limit on axial travel once the capsule is locked onto the bottle.

This locking mechanism ensures that a sufficiently tight tolerance, on the static force that holds the sealing liner inside the capsule top firmly against the glass rim at the top of the bottle, will be maintained in order to ensure that the seal is not compromised by axial movement. In order to ensure that this force is symmetrically distributed around the rim, each subset of tabs of equal axial height is symmetrically distributed circumferentially. For example, with twenty-four tabs equally spaced circumferentially at fifteen degrees, which are partitioned into eight distinct axial heights, there will be three tabs in each subset with one-hundred twenty degree spacing.

The capsule strength required to mitigate capsule crushing and transfer externally applied top load to the threads on the bottle is achieved by a combination of the material strength and the material thickness of individual cooperating portions of the capsule. The thickness in the region that contains the plastic threads is increased, without excessive use of material, by the presence of a protruding band, or thickened circumferential region, disposed along the upper part of the cylindrical portion of the capsule adjacent to the threads on the container. The thickness in the region on top of the capsule that will press down against the rim of the bottle when the capsule is screwed onto the bottle is increased by the presence of a raised annulus, disposed around the outer most portion of the capsule top. This thickened annular region directly transfers load from the top to the sides of the capsule, as well as from the top of the capsule to the bottle-top rim, through a sealing liner, and is increased without excessive use of material by minimizing the radial dimension of the annulus, subject to meeting the strength requirement. This leaves a depressed disc-shaped region in the center of the top of the capsule. This disc-shaped void also facilitates uniform transfer of load around the bottle-top rim.

A reduction in the cost of molding the capsule is achieved by minimizing the need for, or at least the complexity of, an articulating core; this may make the method of strip molding feasible. A further reduction in the cost of production is achieved by minimizing the need for and complexity of any robotics required for assembling parts or creating a breakaway line.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1A is an exploded perspective view of an integrated molded plastic screw-capsule using a threaded capsule bottom and an unthreaded capsule top.

FIG. 1B is a perspective view of the assembled integrated plastic screw-capsule of FIG. 1A, with circumferential slits for breakaway shown somewhat exaggerated for visibility

FIG. 1C is a cross-sectional view of a bottle neck and the integrated plastic screw-capsule of FIG. 1B, and showing a sealing liner (without cross hatch) between the bottle-top rim and the underside of the capsule top.

FIG. 1D is a set of rotated sections of FIG. 1A highlighting the dimensional characteristics of the various closure tabs, and showing that the closure tabs have varying heights to accommodate manufacturing tolerances in the dimensions of the integrated plastic screw-capsule and a bottle neck upon which the capsule would be installed.

FIG. 1E is a side view of the assembled integrated plastic screw-capsule of FIG. 1B.

FIG. 1F is a cross sectional view of the assembled integrated plastic screw-capsule of FIG. 1E looking out of the capsule, and showing the closure tabs.

FIG. 1G is a cross sectional view of the assembled plastic screw-capsule of FIG. 1E, showing the internal threads on the capsule bottom, the closure tabs, and the breakaway line.

FIG. 2A is an exploded perspective view of a second embodiment of an integrated molded plastic screw-capsule, this embodiment using an unthreaded capsule bottom and a threaded capsule top

FIG. 2B is a perspective view of the assembled integrated plastic screw-capsule of FIG. 2A.

FIG. 2C is a side view of the plastic screw-capsule of FIG. 2B.

FIG. 2D is a cross-sectional view of the plastic screw-capsule of FIG. 2C.

FIG. 2E is a cross sectional view looking out of the plastic screw-capsule of FIG. 2B, showing the closure tabs.

FIG. 2F is an enlarged view of the cross-sectional view of FIG. 2D, showing that the capsule top is threaded, and the capsule sleeve is unthreaded.

FIG. 2G is a set of rotated sections of FIG. 2C highlighting the dimensional characteristics of the various closure tabs, and showing that the closure tabs have varying heights to accommodate manufacturing tolerances in the dimensions of the integrated plastic screw-capsule and a bottle neck upon which this capsule would be installed.

FIG. 2H shows an example of dimensional ranges in the upper portion of the assembled screw-capsule shown in FIG. 2C.

FIG. 2I is a cross-section of FIG. 2H showing an example of dimensional ranges in the cross-sectional view.

FIG. 3A is a perspective view of a unitary molded plastic screw-capsule.

FIG. 3B is a side view of the unitary plastic screw-capsule of FIG. 3A.

FIG. 3C is a cross-sectional view of the unitary plastic screw-capsule of FIG. 3B that shows an inserted threaded sleeve, converting the unitary capsule into a screw-capsule, and showing a sealing liner inside the threaded sleeve, and showing a circumferential V-groove for breakaway.

FIG. 3D is a cross sectional view looking out of the unitary plastic screw-capsule of FIG. 3B, showing the closure tabs.

FIG. 3E is an enlarged view of the cross-sectional view of FIG. 3C, showing that the closure tabs have varying heights to accommodate manufacturing tolerances in the dimensions of the unitary molded plastic screw-capsule and a bottle neck over which the capsule would be installed.

FIG. 3F is a set of rotated sections of FIG. 3B highlighting the dimensional characteristics of the six (6) dimensionally distinct closure tabs.

FIG. 3G is a cross sectional view of the side view of FIG. 3B, showing the entire detail of the unitary plastic screw-capsule, including the threaded capsule insert, the sealing liner, and the closure tabs.

FIG. 3H is an enlarged cross sectional view of a portion of FIG. 3G, showing details of a breakaway-line stress-concentrator.

FIG. 3I is a cross section of just the threaded capsule insert.

FIG. 3J is an enlarged view of the capsule wall section shown in FIG. 3G.

FIG. 3K is a side view of a two-layer disc comprising a seal-liner layer and an oxygen-barrier layer.

FIG. 3L is a cross sectional view of the disc shown in FIG. 3K showing an outer annular portion of the oxygen-barrier layer exhibiting a relative low diffusion coefficient and an inner disc-shaped portion of the oxygen-barrier layer, exhibiting a higher diffusion coefficient.

FIG. 3M is a top view of the disc shown in FIG. 3K showing an outer annular portion of the oxygen-barrier layer exhibiting a relative low diffusion coefficient and an inner disc-shaped portion of the oxygen-barrier layer, exhibiting a higher diffusion coefficient.

### DETAILED DESCRIPTION OF THE INVENTION

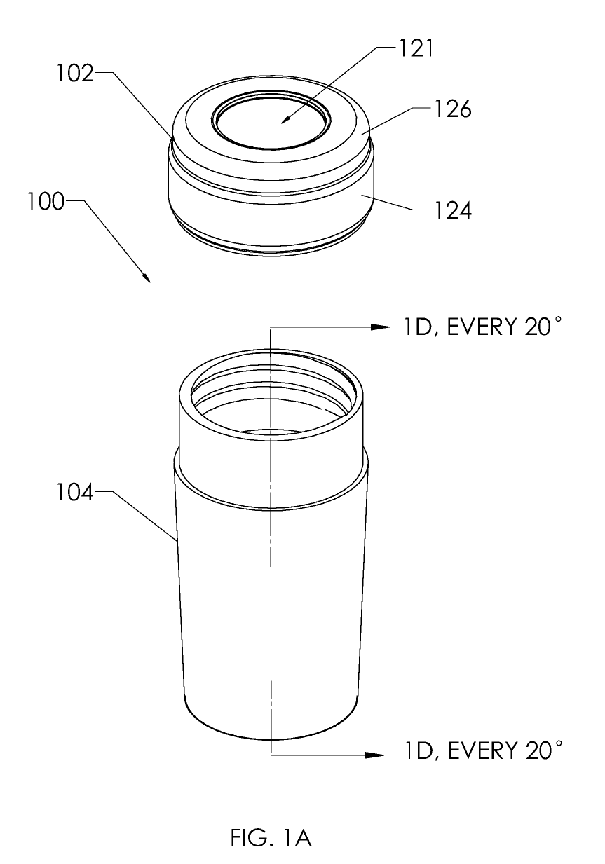

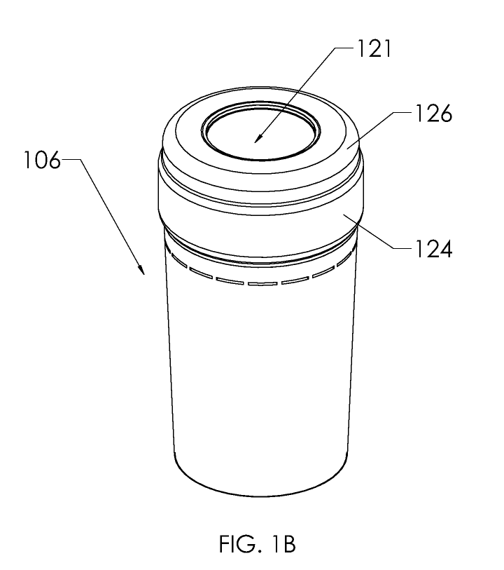

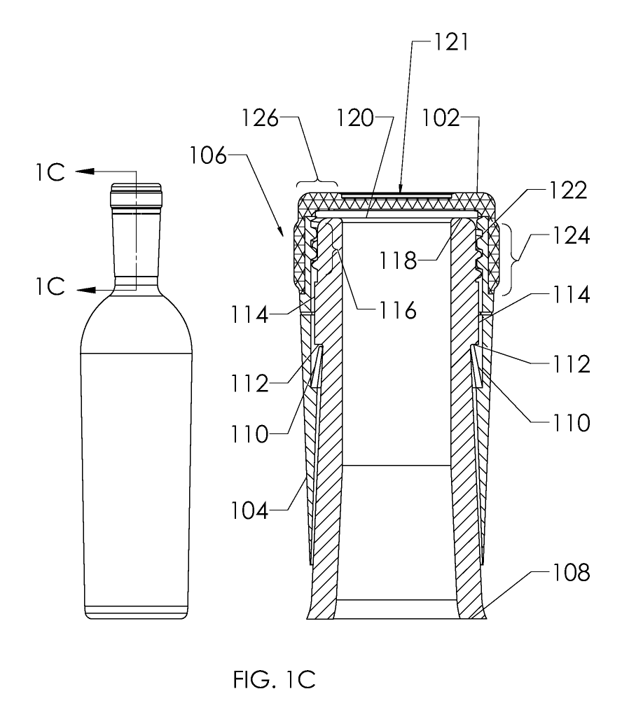

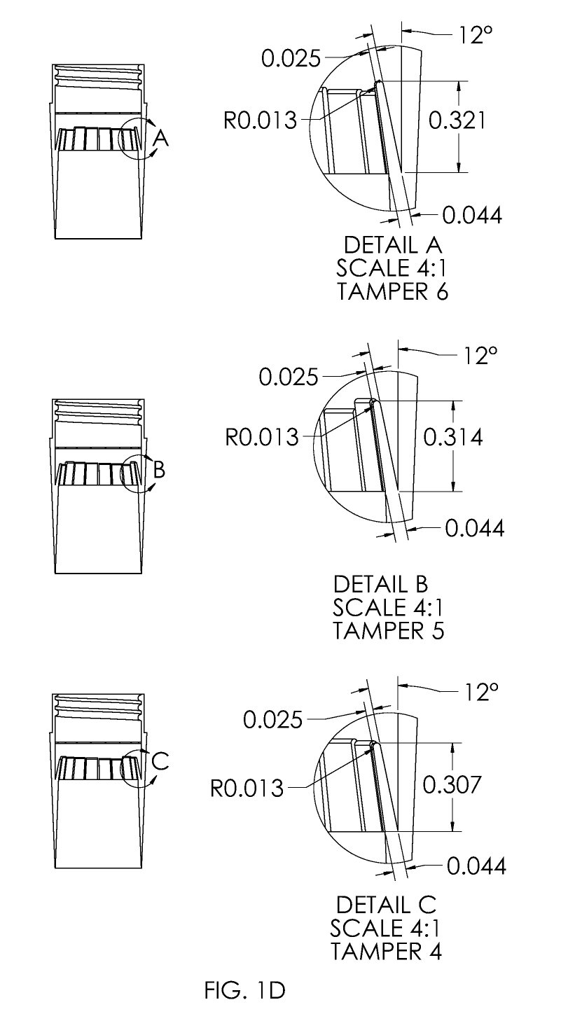

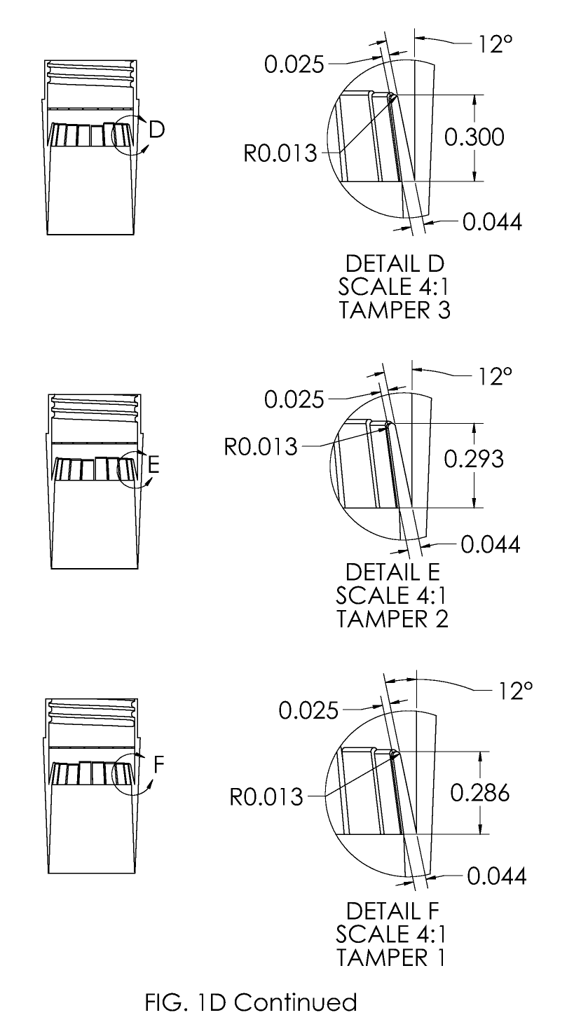

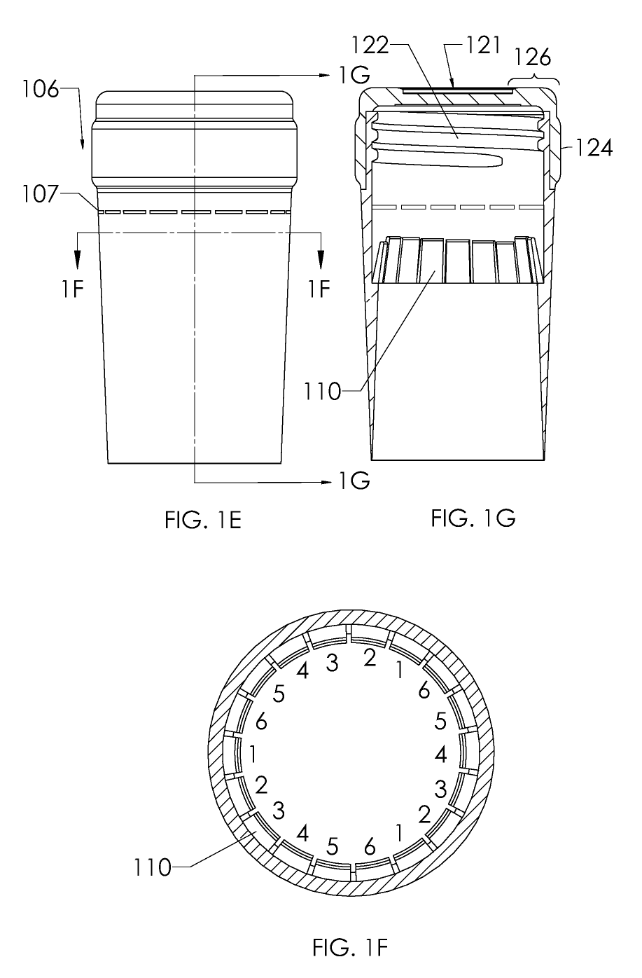

For illustrative purposes the present invention is embodied in the apparatus and methods generally shown in FIG. 1A through FIG. 3M. It will be appreciated that the apparatus may vary as to configuration and as to details of the parts, and that the method may vary as to the specific steps and sequence, without departing from the basic concepts as disclosed herein.

Referring now to the drawings, FIGS. 1A through 1G contain various views of one implementation of a molded plastic screw-capsule 100. Here, FIGS. 1A and 1B show a perspective view of the assembled version of this molded plastic screw-capsule 100, and an exploded version of this view prior to assembly. Capsule top 102 is attached to a capsule sleeve 104 to form an integrated capsule 106.

Refer now to FIG. 1C, which is a cross section of the integrated capsule 106 shown attached to a threaded bottle neck 108. Here, the capsule sleeve 104 is permanently attached to the capsule top 102. The resulting integrated capsule 106 is shown attached to a bottle neck 108 and restrained by closure tabs 110 that are captured and retained by bottle neck 108 lands 112. As used herein, the term “land” means a bearing surface of an annular ring. When the integrated capsule 106 is twisted onto the threaded bottle neck 108, the closure tabs 110 are pressed toward the outer diameter of the capsule sleeve 104 by an outer circumference 114 on the bottle neck 108 that forms the lands 112, and previously, by bottle neck 108 threads 116. Ultimately, the threading of the integrated capsule 106 onto the bottle neck 108 ends with the sealing of the top 118 of the bottle neck 108 against the inner seal 120 disposed within the interior of the capsule top 102.

The composition of the inner seal 120 is chosen so as to be relatively chemically inert when exposed to the contents of the bottle neck 108.

FIG. 1C also shows a disc-shaped relief 121 in the top surface of the capsule top 102 that serves to concentrate the compression forces produced by the capsule in conjunction with the bottle threads uniformly around the rim at the top of the bottle. FIG. 1C further shows a thickened circumferential band 124 on the side and thickened annular region 126 on the top to distribute the stresses in the screw capsule resulting from capsule-application torque and/or top loading in a desired manner to the bottle-top rim and bottle-neck threads.

Referring again to FIG. 1A, a cross section 1D-1D through the capsule sleeve 104 from various rotational angles forms the views of FIG. 1D. Here, we see that the lengths of the closure tabs 110 have a variety of repeating graduated heights, varying sequentially from 0.286, 0.293, 0.300, 0.307, 0.314, to 0.321 inches.

These variations in closure tabs 110 are perhaps better observed by referring to FIG. 1F, which is a cross section of the integrated capsule 106 viewing the various closure tabs 110. Each of these closure tabs 110 are numbered, corresponding to the cross sections shown in FIG. 1D. Thus, there are differing lengths of closure tabs 110 so as to better adapt to differing heights of bottle neck 108 lands 112, distances from the lands 112 to the top 118, and differences in thicknesses of inner seals 120. Therefore, these differing tab lengths take into account manufacturing tolerances in the dimensions of the integrated capsule and a bottle neck 108 upon which this capsule would be installed. These tolerances result in a variation in the distance between closure tabs 110 and bottle neck 108 lands 112 for a specific tab length.

Due to the difference in heights of the closure tabs 110 of only 0.007″, the integrated capsule 106 can be untwisted no more than 0.007″ in axial movement prior to initiation of compression of one set of the closure tabs 110 against the bottle neck 108 lands 112. In typical screw-cap wine bottles, the threads 116 are disposed at about 8 threads per inch, so very little rotation of the integrated capsule 106 is necessary to begin actuating the tamper evidence feature of the integrated capsule 106. The objective that tampering be evident with less axial movement of the threaded portion of the capsule sleeve 104 of the integrated capsule 106 than that required to compromise the seal created by the compressed liner can be met by using enough tabs to reduce free axial movement sufficiently and by designing for separation at the breakaway line with small enough axial movement while the tabs are under compression.

FIG. 1E is a side view of the integrated capsule 106 and shows periodic slits 107 that are disposed circumferentially about the integrated capsule 106.

Note that, in the embodiment of FIGS. 1A-1G, the capsule sleeve 104 may be preinstalled on the bottle neck 108, even prior to filling the bottle with contents. Alternatively, it may be installed after filing the bottle. If there are already contents present in the bottle and the capsule sleeve 104 is also present, then the attachment of the capsule top 102 to the capsule sleeve 104 actually serves to seal the bottle contents through the compression of the seal 120 between the capsule top 102 and the bottle neck 108 top 118.

Alternatively, the bottle (of which the bottle neck 108 forms a part) may be filled with its contents, and the integrated capsule 106 may be threaded onto the bottle neck 108 through the mating of the bottle neck 108 threads 116 and mating threads 122 on an inner diameter of the capsule sleeve 104. This is the preferred method for application of the screw-capsule to the bottle.

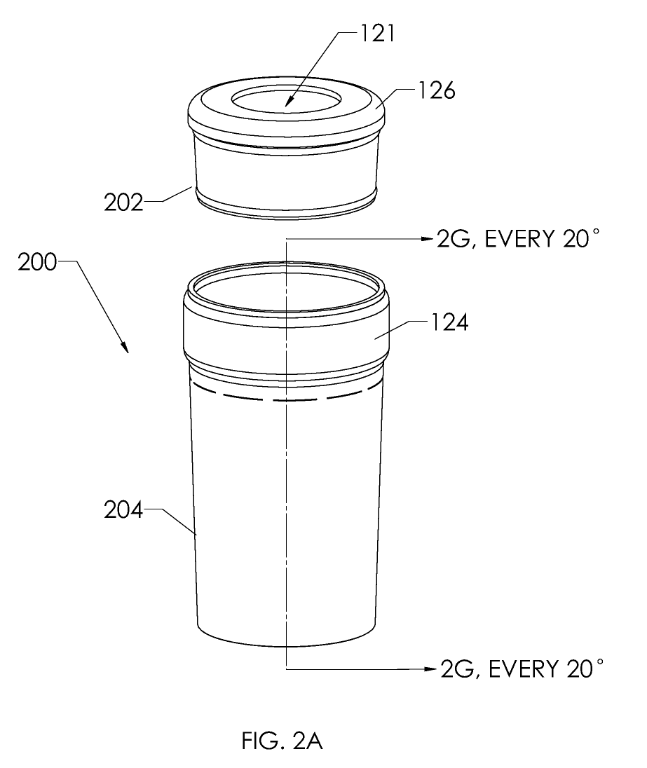

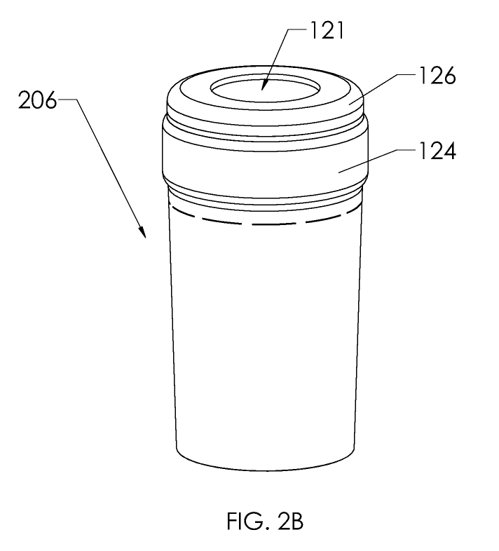

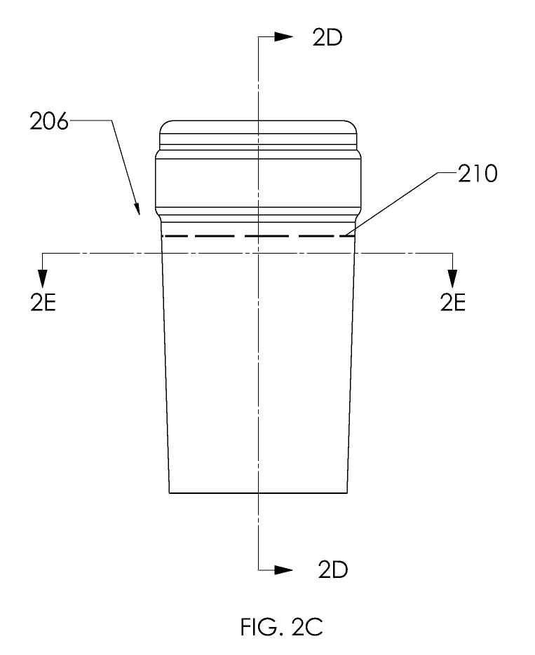

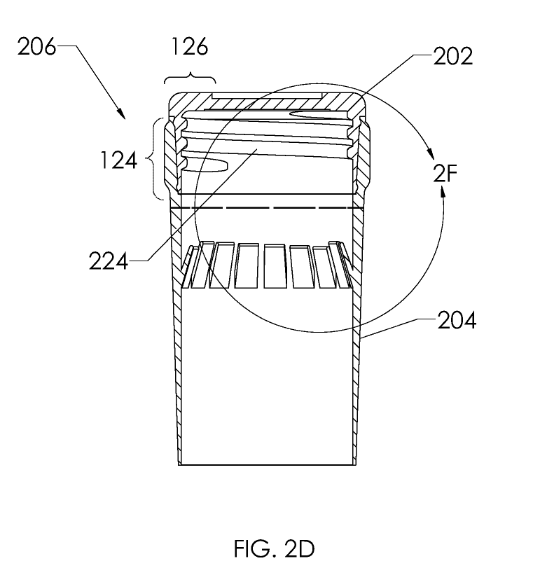

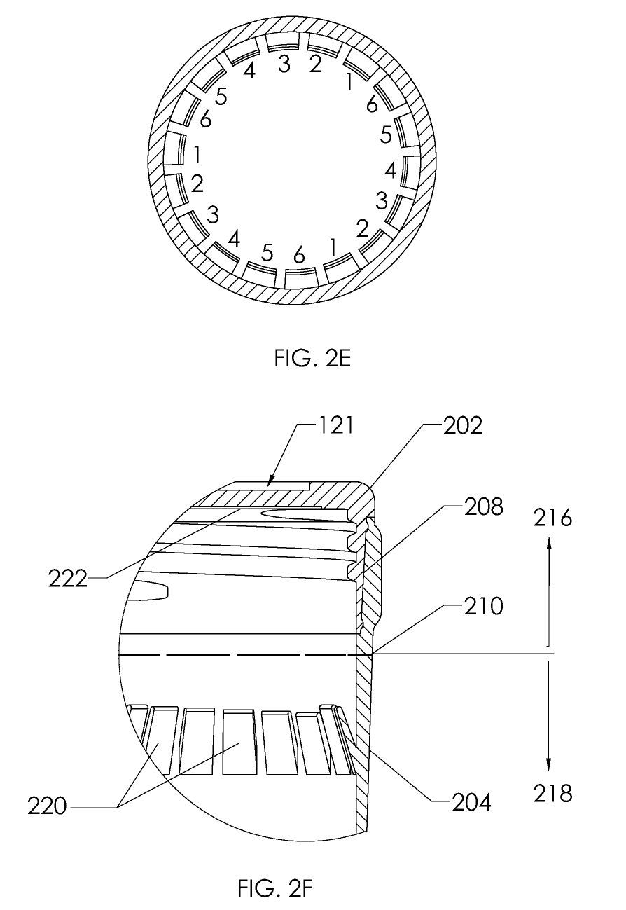

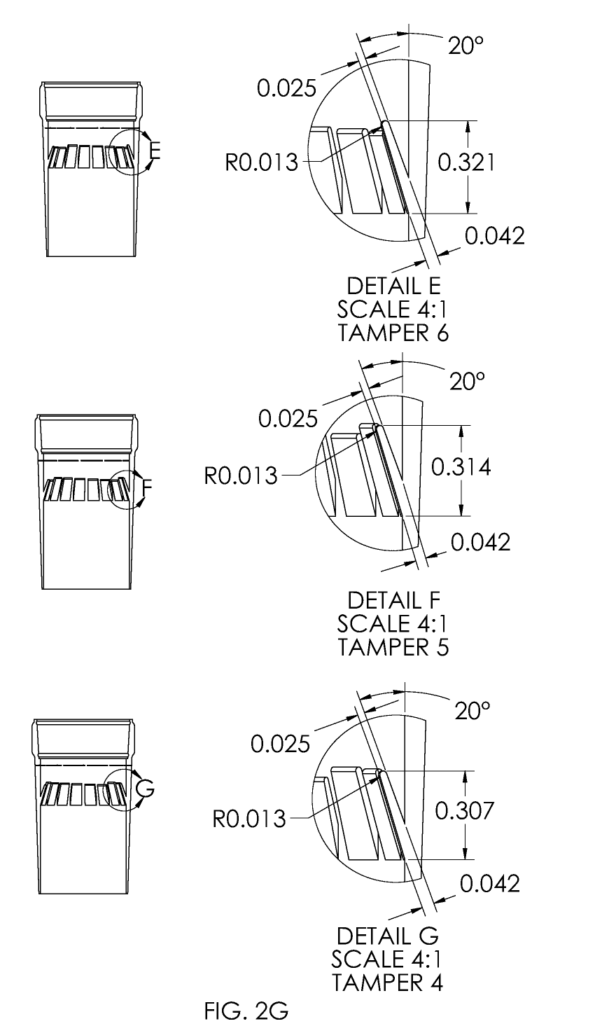

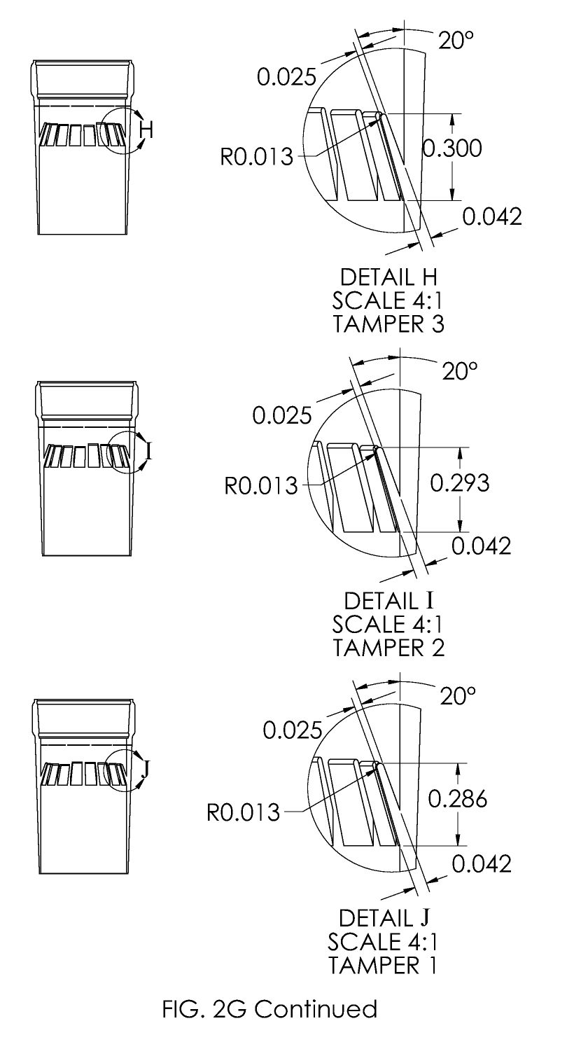

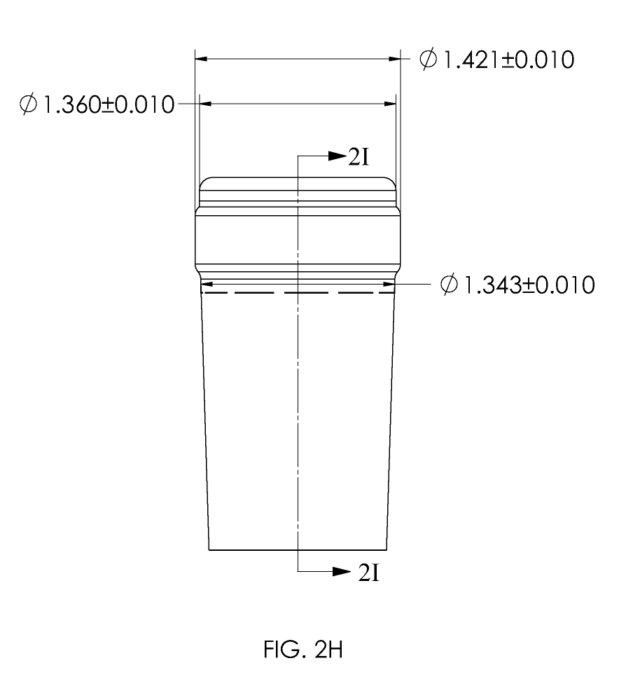

Refer now to FIGS. 2A through 2I, which contain various views of an another embodiment of a molded plastic screw-capsule 200. Here, FIGS. 2A and 2B show a perspective view of the assembled version of this molded plastic screw-capsule 200, and an exploded version of this view prior to assembly. Capsule top 202 is attached to a capsule sleeve 204 to form an integrated capsule 206.

FIG. 2C shows the apparatus of FIG. 2B in a side view, with sections taken vertically (FIG. 2D) and horizontally (FIG. 2E). FIG. 2C also highlights the periodic circumferential slits 210.

In FIG. 2D, we see that the integrated screw-capsule 206 comprises a capsule top 202, and a capsule sleeve 204. Further, the capsule top 202 is threaded with threads 224, instead of the capsule sleeve 204 being threaded as described above for the embodiment depicted in FIGS. 1A-1G.

FIG. 2F shows an enlarged section of FIG. 2D, detailing the junction 208 between the capsule top 202 and capsule sleeve 204, and showing the breakaway line along which slits 210 are distributed.

Previously shown in the embodiment of the invention above disclosed in FIGS. 1A-1G, the breakaway line comprises a set of periodic circumferential slits 107 in FIG. 1E. Similarly, this embodiment is indicated with the slits 210 in FIG. 2C.

By way of example, and not of limitation, the circumferential slits 210 leave only a small portion of capsule sleeve 204 remaining between each slit. These slits form a breakaway line, allowing separation of the integrated screw-capsule 206 into two sections without undue effort. These slits 210 comprise a series of slit arcs (e.g., 5 mm long) with relatively short (e.g., ½ mm or less) un-slit arcs of capsule sleeve 204 material between them that function as stress concentrated segments. The very short length of these arcs enables them to break with only a modest level of axial tensile force, allowing the portion of the integrated screw-capsule upper section 216 in FIG. 2F above the breakaway line 210 to detach from the lower section 218 below the breakaway line 210.

FIG. 2F also shows a disc-shaped relief 221 in the top surface of the capsule top 202 that serves to concentrate the compression forces produced by the capsule in conjunction with the bottle threads uniformly around the rim at the top of the bottle.

Present but not shown in the embodiment of the invention disclosed in FIGS. 1A-1G, and present as well as shown in the embodiment of the invention disclosed in FIGS. 2A-2I, the section 216 above the breakaway line 210 of the capsule in FIG. 2F comprises a reseal cap. By threading it back down onto the bottle after it has been removed from the bottle, the bottle may be resealed. Not shown here is the bottle neck cross section, where the closure tabs 220 clasp upon the bottle neck land, thereby retaining the lower section 218 to the bottle neck.

Additionally, there is a sealing liner present but not shown in the capsule top 202, and also present but shown as part 120 in FIG. 1C, disposed between the underside of the top of the capsule assembly and the rim at the top of the container. The liner may comprise material that either prevents wine leakage or controls oxygen transfer rate into the container or both.

FIG. 2E shows a cross sectional view of the closure tabs 220 looking down through the integrated capsule 200. FIG. 2G in turn shows the detailed configurations of the various closure tabs 220, which may be seen to have graduated heights of 0.286, 0.293, 0.300, 0.307, 0.314, and 0.321 inches.

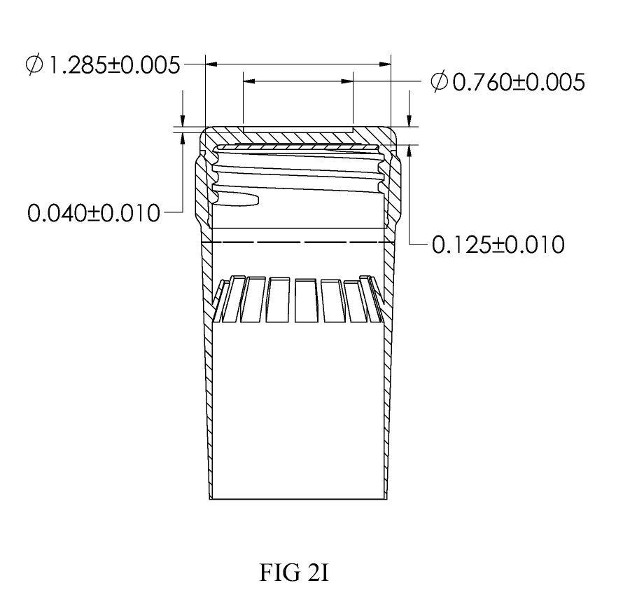

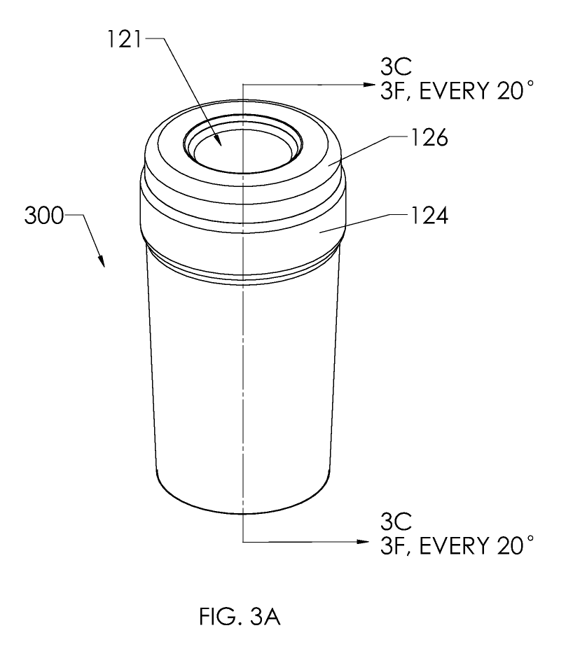

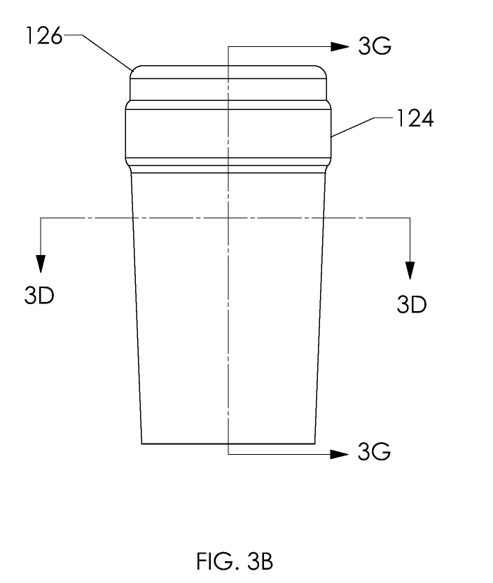

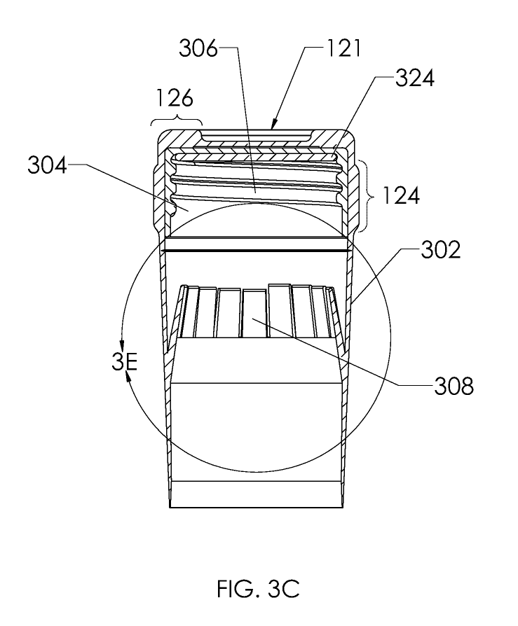

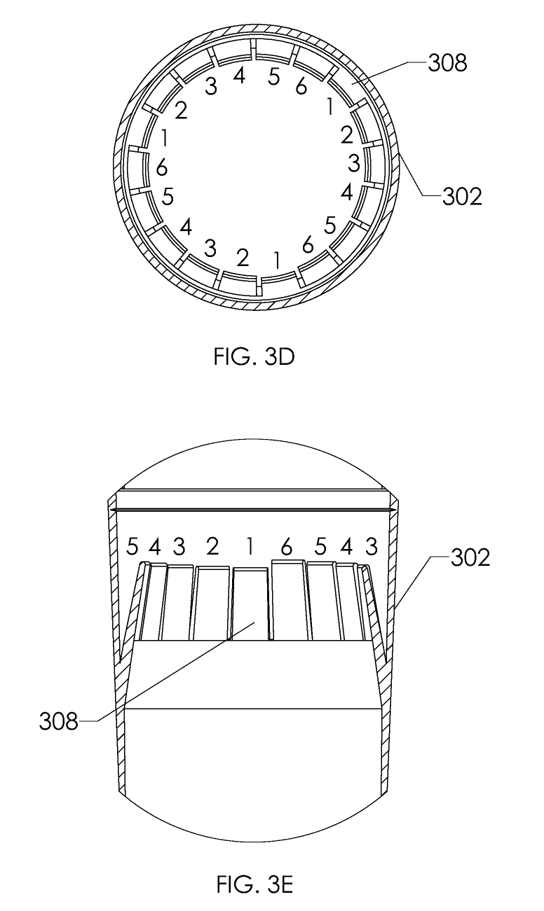

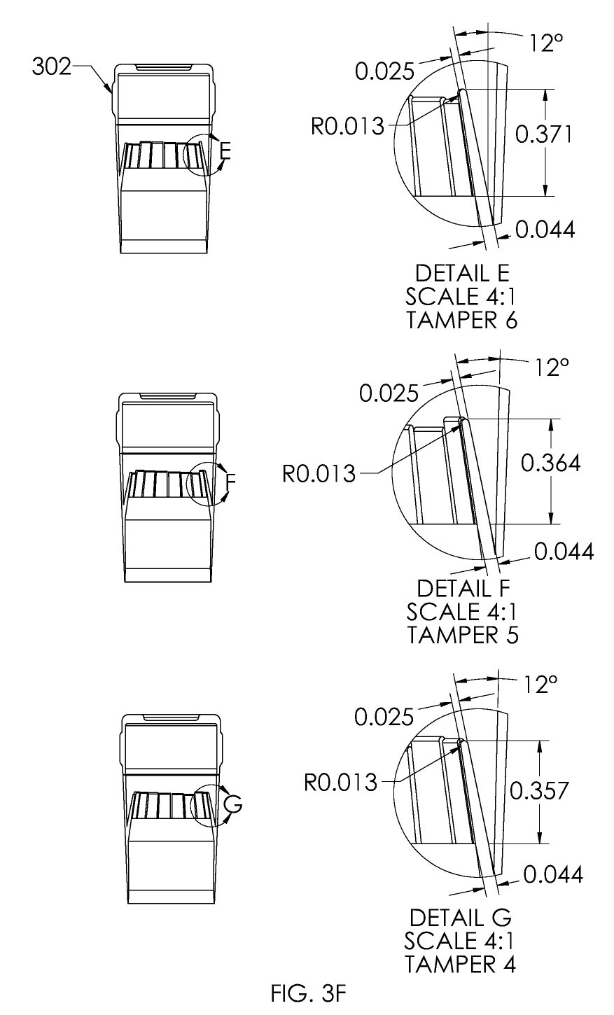

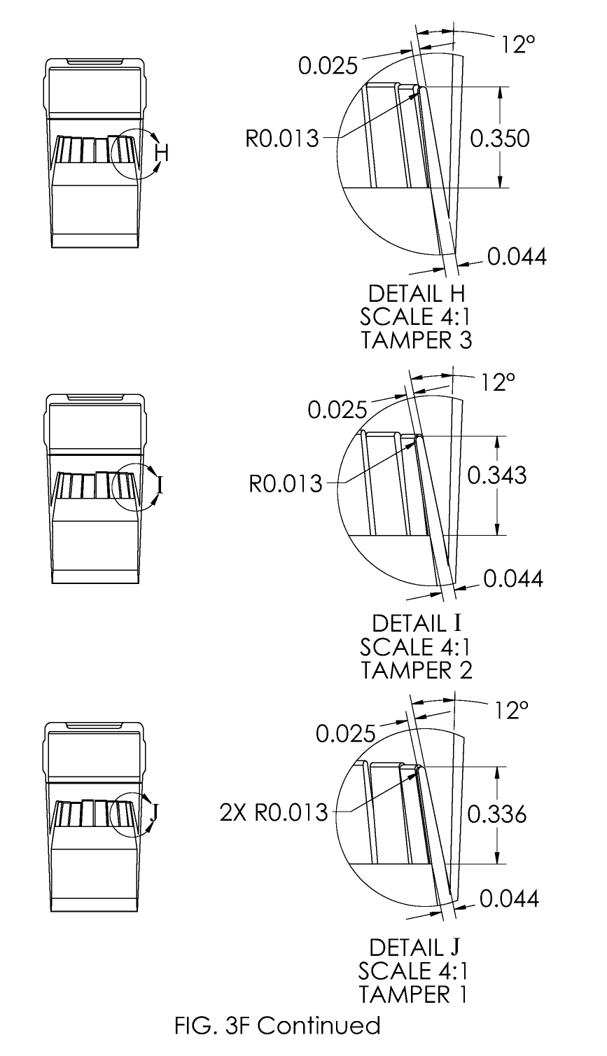

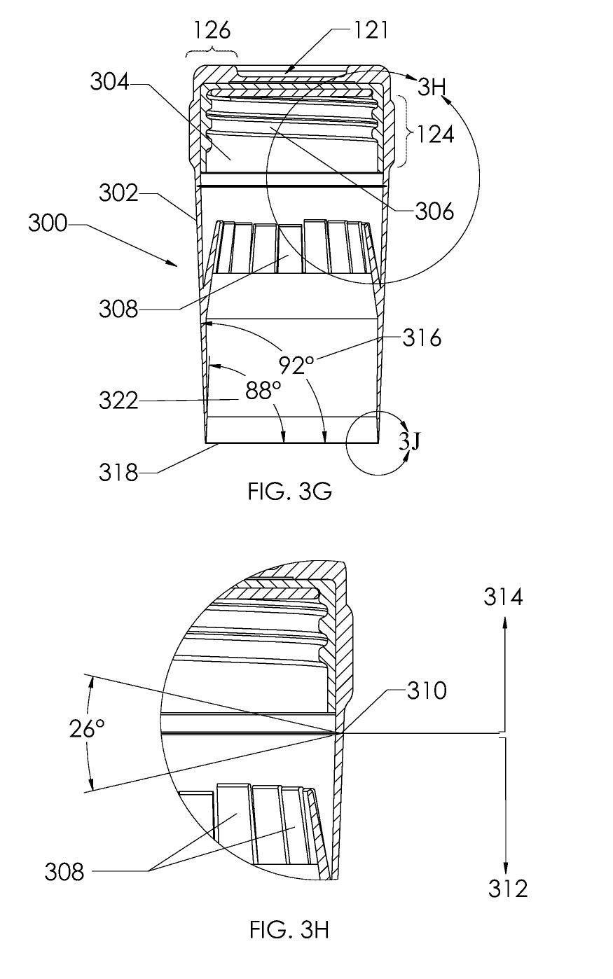

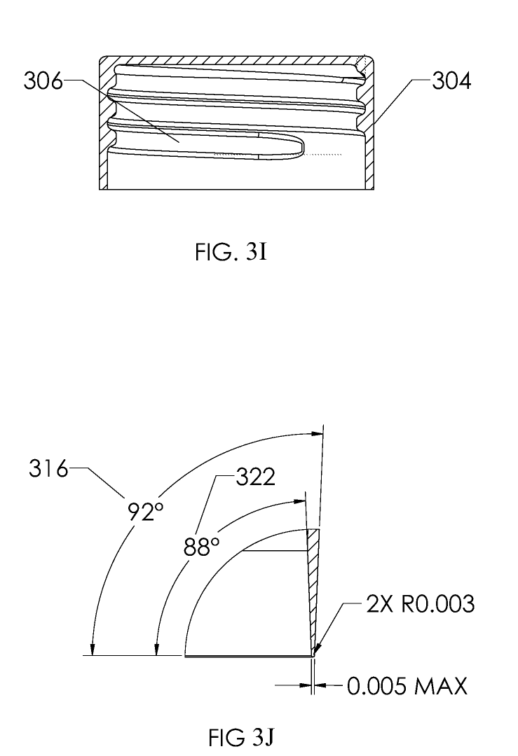

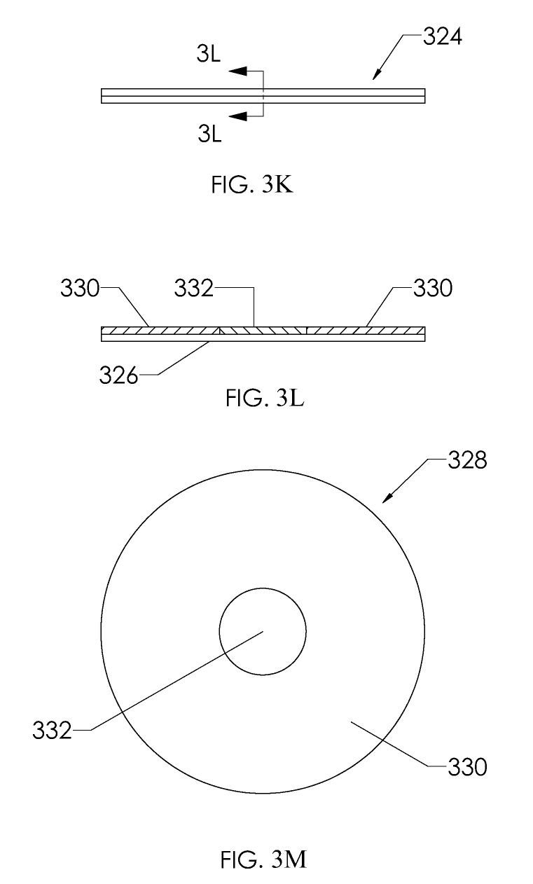

FIGS. 2H-2I contain a side view of the embodiment illustrated in FIGS. 2A-2G, and a cross-section from this side view. Incorporated in these two drawings, as an example only, is a set of dimensional ranges that, with an appropriate material like low-density polyethylene for example, enables the screw-capsule, with cooperating thickened circumferential band 124 and thickened annular region 126 on the top, as shown in these figures, to distribute the stresses in the screw capsule resulting from capsule-application torque and/or top loading in a desired manner to the bottle-top rim and bottle-neck threads, as explained above in connection with the embodiments shown in FIGS. 1A-1G and 2A-2G, and below in connection with the embodiment shown in FIGS. 3A-3M.

Refer now to FIGS. 3A through 3M, beginning with FIG. 3A, which is a perspective view of a unitary bottle capsule 300. FIG. 3B is a side view of this embodiment of the molded screw-capsule. FIG. 3C is a cross section of the unitary bottle capsule 300 of FIG. 3A.

With FIG. 3C, we see the first inkling of the differences between the unitary capsule and the previously described embodiments of the invention. Here, a unitary capsule 302 comprises a sleeve-with-a-top forms the entire exterior surface of the unitary capsule 300, with a separate threaded capsule insert 304 forming the threads 306 inside.

FIG. 3D shows the sectional view of the closure tabs 308 taken from the downward looking sectional view of FIG. 3B. Here, the outer perimeter of the unitary capsule sleeve 302 is also seen.

FIG. 3E is an enlarged cross-sectional view of the cross section of FIG. 3C. Here, the perimeter of the unitary capsule 302 is seen, as is the varying length nature of the closure tabs 308. From FIGS. 3D and 3E together, it is seen that there are 18 closure tabs 308, in three sets of six different heights. This and the other two embodiments of this invention described above may contain fewer or more tabs. The number of tabs is a design parameter that can be optimized for best functionality.

FIG. 3F details the sectional views of the closure tabs 308 as they vary in graduated heights from 0.336, 0.343, 0.350, 0.357, 0.364, and 0.371 inches to accommodate manufacturing tolerances in the dimensions of the unitary capsule and a bottle neck upon which this screw-capsule would be installed. These tolerances result in variation in the distance between closure tabs and bottle neck land, not shown here but shown as 112 in FIG. 1C, for a specific tab length. In FIG. 3F, only the unitary capsule 302 is shown, without the threaded insert shown.

FIG. 3G is a detailed cross section of the side view of FIG. 3B. Here, the unitary capsule sleeve 302 is shown surrounding and attached to the separate threaded capsule insert 304 having its threads 306 inside.

The composition of the threaded capsule insert 304 may be chosen so as to be chemically compatible with the contents of a bottle sealed with the unitary capsule 300. Additionally, the threaded capsule insert 304 may be directly formulated so as to achieve an optimal oxygen transfer rate, thereby directly sealing to the bottle. Referring back to FIG. 1A, such a formulation may be used as well in the prior embodiments, where the capsule top 102 or the capsule sleeve 104 may comprise such a formulation. Similarly, Referring back to FIG. 2D, the capsule top 202 or the capsule sleeve 204 may be so formulated so as to achieve a desired oxygen transfer rate with or without the use of a sealing liner.

Additionally, FIG. 3C shows an optionally included sealing liner 324 in the threaded insert 304 in FIG. 3I disposed between the underside of the top of this threaded insert 304 and the rim at the top of the container. The sealing liner 324 may comprise material that either prevents wine leakage or controls oxygen transfer rate into the container or both.

FIG. 3H is an enlargement of a portion of the cross section of FIG. 3G, detailing the breakaway line 310. Here, the breakaway line 310 is a circumferential angled section, or V-shaped circular groove, that acts as a stress concentrator in the unitary capsule sleeve 302. Since the breakaway line 310 comes to a sharp point, stress concentration is maximized, thereby more easily allowing the portion of the screw-capsule upper section 314 above the breakaway line 310 to detach from the lower section 312 below the breakaway line 310.

Alternatively, the breakaway line 310 may be stress concentrated by using a periodically repeating pattern of slits as illustrated in FIGS. 1E and 2C, such as a long slits (e.g., 5 mm) separated by short solid sections (e.g., 0.5 mm or less) with no slit. Only the short un-slit sections (the solid portions of the breakaway line 310) need to be broken to actuate evidence of tampering and separate the breakaway line 310.

When sufficient unscrewing torque is applied to the unitary capsule 302, the lower portion 312 below the breakaway line 310 separates from the upper portion 314 due to the threads exerting a force between the upper portion 314 and the lower portion 312. The force in the lower portion 312 is due to the action of the closure tabs 308 grasping a land on the bottle neck (neither shown). After separation of the lower portion 312 and the upper portion 314, the upper portion 314 may be removed and it may be replaced for resealing the bottle.

Therefore, in operation, the unitary capsule 300 initially appears to be a traditional foil or foil look-alike (e.g., polylaminate) decoration on the neck of a wine bottle sealed with a cork. However, upon unscrewing the unitary capsule 300, the lower portion 312 and the upper portion 314 separate. This separation is permanent, and it is an indication that the bottle to which the lower portion is attached has been exposed to tampering. Upon completion of the unscrewing, the upper portion 314 of the capsule comes off the bottle top, revealing that this is not a cork-sealed bottle as it first appeared to be, but rather is a screw-cap sealed bottle. The separated upper portion functions as a reseal cap. This same description of operation applies to the previous embodiments depicted in FIGS. 1A-1G and FIGS. 2A-2G.

Finally completing all major embodiments of the unitary capsule 300, FIG. 3I shows a separate cross section of the threaded capsule insert 304 with formed threads 306 inside. This threaded capsule insert 304 is inserted into and attached to the interior of the unitary capsule 302 in operation. Such attachment may be by straightforward mechanical means (a preferred embodiment) or by ultrasonic bonding, glue, solvent, thermosonic bonding, heat bonding, or other adhesive bonding. The bond, while not limited to being permanent, does not need to be temporary.

Refer again to previously mentioned FIG. 3G, and to FIG. 3J. Here, it is pointed out that the outer angle of the taper 316 of the unitary capsule sleeve 302 is about 92° relative to the bottom 318. The interior taper 320 of the unitary capsule sleeve 302 is less, perhaps 88°, allowing the threaded-cap insert 304 to be more readily inserted into the unitary capsule 302.

FIG. 3J shows an enlarged view of the section of FIG. 3G, in order to better reveal the taper of the unitary capsule 302, which can neck down to a thickness of only about 0.127 millimeters (0.005″) but which preferably has a thickness of approximately 0.020 to 0.030 inches. This same description applies to the other embodiments of this invention depicted in FIGS. 1A-1G and FIGS. 2A-2I. One objective for this thinness is to give the screw-capsule the outside appearance of a traditional foil wrap on the bottle neck.

The unitary capsule of FIGS. 3A-3M and the integrated capsules of FIGS. 1A-1G and 2A-2I all feature a raised or thickened circumferential band 124 adjacent to the bottle threads. This feature complements the annular feature atop the screw cap for the purpose of transferring top load on the screw-capsule to threads on the bottle, and possibly to the bottle neck region. Additionally, the top of the plastic screw-capsule comprising any of the unitary capsule of FIGS. 3A-3M or the integrated capsules of FIGS. 1A-1G and 2A-2I features a “raised” or thickened annular region or ring 126 which forms a disc-shaped relief 121 in the top surface of the capsule top that serves to concentrate the compression forces produced by the capsule in conjunction with the bottle threads uniformly around the rim at the top of the bottle. This feature imparts an important functionality of transferring a top load to the bottle threads, and possibly to the bottle neck region. This load transfer ultimately enables pallets of cases of the bottles to be stacked much higher, conserving temperature controlled floor space required for product storage.

FIG. 3K shows a side view of a two-layer seal-liner disc 324 comprising a lower seal layer and an upper diffusion-barrier layer which may limit the rate of oxygen transfer into the container. FIG. 3L shows a cross section of this disc 324 revealing an outer annular portion 330 of the diffusion-barrier layer and an inner disc-shaped portion 332 of this layer, that may be bonded to the annular portion in a manner that largely eliminates oxygen transfer through the bond junction between the two portions. FIG. 3M shows a top view of the diffusion-barrier layer 328, comprising outer annular portion 330 and inner disc portion 332. Each of the two layers may comprise multiple layers within themselves. For example, the seal layer may comprise a resilient compressible layer above and a liquid-impervious inert layer below.

The diffusion barrier may be selected from a group of diffusion barriers including those that may contain passive gas barriers or chemically reactive gas transmission oxygen scavenging agents and may include metals and plastics, such as ethylene vinyl alcohol polymer (EVOH), nylon, nylon compounds, thermoplastics including elastomers, polyisobutylene, polybutylene; polyethylene, metalized polyethylene terephthalate, and others.

The outer annular portion 330 of the barrier may comprise a high barrier to oxygen transfer with a very low coefficient of diffusion that may limit total oxygen ingress over a period of one or more years to a negligible level from a wine-oxidation standpoint, and the inner disc portion 332 may comprise a lower barrier with a higher coefficient of diffusion. This lower barrier may be interpreted as a window in the wall comprising the higher barrier that enables more oxygen to enter the container than the wall alone would. The surface area and thickness of this window as well as the material from which it is made may be selected to customize the overall oxygen transfer rate into the container so as to optimize the aging of wine. For some wine, no oxygen transfer is desired and the disc may be omitted.

The particular shapes and positions of the two barrier materials may be different from the annulus and disc described here. All that is relevant, geometrically, to the objective of customizing oxygen transfer rate is the surface area and thickness of the material with the higher coefficient of diffusion. The barriers may also be multilayered.

From the foregoing description it will be appreciated that the present invention may be embodied in various ways, which include but are not limited to the following:

1. An apparatus for sealing a container, comprising: a threaded capsule; and means associated with said capsule for sealing a liquid within a container of the type having an opening with threads adjacent the opening.

2. An apparatus according to embodiment 1, wherein said capsule comprises a plastic material selected from a group of plastic materials consisting essentially of: polyethylene (PE) of all densities (LDPE to HDPE), polyethylene terephthalate (PET), recycled polyethylene terephthalate, cross-linked polyethylene (PET), polyphenyl ether (PPE), polyvinyl chloride (PVC), polyvinylidene chloride (PVDC), polylactic acid (PLA), polypropylene (PP), polybutylene (PB), polybutylene terephthalate (PBT), polyamide (PA), polyimide (PI), polycarbonate (PC), polytetrafluoroethylene (PTFE), polystyrene (PS), polyurethane (PU), polyester (PEs), acrylonitrile butadiene styrene (ABS), polymethyl methacrylate (PMMA), polyoxymethylene (POM), polysulfone (PES), styrene-acrylonitrile (SAN), ethylene vinyl acetate (EVA), styrene maleic anhydride (SMA), one or more of the foregoing, and glass or other insoluble structural fiber fillings mixed within the foregoing.

3. An apparatus according to embodiment 1, wherein said capsule comprises a threaded sleeve portion with an unthreaded top portion, or an unthreaded sleeve portion with a threaded top portion, or a threaded sleeve portion with a threaded top portion.

4. An apparatus according to embodiment 3, wherein the sleeve portion and top portion are a unitary member.

5. An apparatus according to embodiment 3, wherein the sleeve portion and top portion comprise separate sleeve and top members attached to each other.

6. An apparatus according to embodiment 3, wherein said threads are integrated into the sleeve or top portions.

7. An apparatus according to embodiment 3, wherein said threads comprise one or more separate threaded inserts.

8. An apparatus according to embodiment 1: wherein said container has a top portion and a rim adjacent the top portion; wherein said capsule has a top portion with an underside; wherein said means for sealing comprises a liner in said capsule; and wherein when said capsule is on the container and in a sealed position, the liner is disposed between the underside of the top portion of said capsule and the rim at the top of the container.

9. An apparatus according to embodiment 8, wherein said capsule includes a “breakaway” or “separation” line.

10. An apparatus according to embodiment 1: wherein said container has an opening and a land disposed about the opening; wherein said capsule has a sleeve portion and a top portion; wherein said means for sealing comprises a plurality of closure tabs of three or more heights on the sleeve portion of said capsule that are configured to clasp the land on the container; and wherein said capsule includes a separation line for separation of the top portion of said capsule from the sleeve portion of said capsule.

11. An apparatus according to embodiment 1, wherein said means for sealing comprises: a thickened annular or circumferential region in the capsule, or both, that compresses against the container to form a seal.

12. An apparatus according to embodiment 1, wherein said means for sealing comprises a multi-layer sealing liner comprising some or all of a liquid-sealing layer, a resilient compressible layer, and an oxygen-transfer-rate (OTR) controlling layer, wherein the OTR-controlling layer comprises an oxygen-blocking means with a window comprising oxygen transfer means consisting of a material with specifiable oxygen transfer rate higher than that of the oxygen-blocking means.

13. A container system, comprising: a container having a neck portion with threads positioned along the neck portion; a threaded capsule, said threaded capsule having threads configured to mate with at least a portion of the threads on the container; and means associated with said capsule for sealing a liquid within the container.

14. A system according to embodiment 13, wherein said capsule comprises a plastic material selected from a group of plastic materials consisting essentially of: polyethylene (PE) of all densities (LDPE to HDPE), polyethylene terephthalate (PET), recycled polyethylene terephthalate, cross-linked polyethylene (PET), polyphenyl ether (PPE), polyvinyl chloride (PVC), polyvinylidene chloride (PVDC), polylactic acid (PLA), polypropylene (PP), polybutylene (PB), polybutylene terephthalate (PBT), polyamide (PA), polyimide (PI), polycarbonate (PC), polytetrafluoroethylene (PTFE), polystyrene (PS), polyurethane (PU), polyester (PEs), acrylonitrile butadiene styrene (ABS), polymethyl methacrylate (PMMA), polyoxymethylene (POM), polysulfone (PES), styrene-acrylonitrile (SAN), ethylene vinyl acetate (EVA), styrene maleic anhydride (SMA), one or more of the foregoing, and glass or other insoluble structural fiber fillings mixed within the foregoing.

15. A system according to embodiment 14, wherein said capsule comprises a threaded sleeve portion with an unthreaded top portion, or an unthreaded sleeve portion with a threaded top portion, or a threaded sleeve portion with a threaded top portion.

16. A system according to embodiment 15, wherein the sleeve portion and top portion are a unitary member.

17. A system according to embodiment 15, wherein the sleeve portion and top portion comprise separate sleeve and top members attached to each other.

18. A system according to embodiment 15, wherein said threads are integrated into the sleeve or top portions.

19. A system according to embodiment 15, wherein said threads comprise one or more separate threaded inserts.

20. A system according to embodiment 13: wherein said container has a top portion and a rim adjacent the top portion; wherein said capsule has a top portion with an underside; wherein said means for sealing comprises a liner in said capsule; and wherein when said capsule is on the container and in a sealed position, the liner is disposed between the underside of the top portion of said capsule and the rim at the top of the container.

21. A system according to embodiment 20, wherein said capsule includes a “breakaway” or “separation” line.

22. A system according to embodiment 13: wherein said container has an opening and a land disposed about the opening; wherein said capsule has a sleeve portion and a top portion; wherein said means for sealing comprises a plurality of closure tabs of three or more heights on the sleeve portion of said capsule that are configured to clasp the land on the container; and wherein said capsule includes a separation line for separation of the top portion of said capsule from the sleeve portion of said capsule.

23. A system according to embodiment 13, wherein said means for sealing comprises: a thickened annular or circumferential region in the capsule that compresses against the container to form a seal.

24. A system according to embodiment 13, wherein said means for sealing comprises a multi-layer sealing liner comprising some or all of a liquid-sealing layer, a resilient compressible layer, and an oxygen-transfer-rate (OTR) controlling layer, wherein the OTR-controlling layer comprises an oxygen-blocking means with a window comprising oxygen transfer means consisting of a material with specifiable oxygen transfer rate higher than that of the oxygen-blocking means.

25. A method for sealing a container of the type having a neck portion with threads positioned along the neck portion, said method comprising: rotatably coupling a threaded capsule to said container, said capsule comprising: a threaded capsule, said threaded capsule having threads configured to mate with at least a portion of the threads on the container; and means associated with said capsule for sealing a liquid within the container.

26. A method according to embodiment 25, wherein said capsule comprises a plastic material selected from a group of plastic materials consisting essentially of: polyethylene (PE) of all densities (LDPE to HDPE), polyethylene terephthalate (PET), recycled polyethylene terephthalate, cross-linked polyethylene (PET), polyphenyl ether (PPE), polyvinyl chloride (PVC), polyvinylidene chloride (PVDC), polylactic acid (PLA), polypropylene (PP), polybutylene (PB), polybutylene terephthalate (PBT), polyamide (PA), polyimide (PI), polycarbonate (PC), polytetrafluoroethylene (PTFE), polystyrene (PS), polyurethane (PU), polyester (PEs), acrylonitrile butadiene styrene (ABS), polymethyl methacrylate (PMMA), polyoxymethylene (POM), polysulfone (PES), styrene-acrylonitrile (SAN), ethylene vinyl acetate (EVA), styrene maleic anhydride (SMA), one or more of the foregoing, and glass or other insoluble structural fiber fillings mixed within the foregoing.

27. A method according to embodiment 26, wherein said capsule comprises a threaded sleeve portion with an unthreaded top portion, or an unthreaded sleeve portion with a threaded top portion, or a threaded sleeve portion with a threaded top portion.

28. A method according to embodiment 27, wherein the sleeve portion and top portion are a unitary member.

29. A method according to embodiment 27, wherein the sleeve portion and top portion comprise separate sleeve and top members attached to each other.

30. A method according to embodiment 27, wherein threads are integrated into at least one of the threaded portions.

31. A method according to embodiment 27, wherein a threaded insert is coupled to at one of the threaded portions.

32. A method according to embodiment 25: wherein said container has a top portion and a rim adjacent the top portion; wherein said capsule has a top portion with an underside; wherein said means for sealing comprises a liner in said capsule; and wherein when said capsule is on the container and in a sealed position, the liner is disposed between the underside of the top portion of said capsule and the rim at the top of the container.

33. A method according to embodiment 32, wherein said capsule includes a “breakaway” or “separation” line.

34. A method according to embodiment 25: wherein said container has an opening and a land disposed about the opening; wherein said capsule has a sleeve portion and a top portion; wherein said means for sealing comprises a plurality of closure tabs of three or more heights on the sleeve portion of said capsule that are configured to clasp the land on the container; and wherein said capsule includes a separation line for separation of the top portion of said capsule from the sleeve portion of said capsule.

35. A method according to embodiment 25, wherein said means for sealing comprises: a thickened annular or circumferential region in the capsule, or both, that compresses against the container to form a seal.

36. A method according to embodiment 25, wherein said means for sealing comprises a multi-layer sealing liner comprising some or all of a liquid-sealing layer, a resilient compressible layer, and an oxygen-transfer-rate (OTR) controlling layer, wherein the OTR-controlling layer comprises an oxygen-blocking means with a window comprising oxygen transfer means consisting of a material with specifiable oxygen transfer rate higher than that of the oxygen-blocking means.

37. An apparatus for sealing a bottle having a neck, comprising: a threaded capsule; a thickened annular region disposed at a top of the capsule; and a sealing liner disposed within the threaded capsule; wherein the thickened annular region is substantially disposed above a top of the bottle neck; whereby a compressive load placed upon the thickened annular region is transferred partially to a capsule portion below a capsule top, and partially to the sealing liner, and ultimately to the top of the bottle neck.

38. An apparatus for sealing a bottle with a threaded neck, comprising: a threaded capsule; a thickened circumferential region disposed about the sides of the capsule; wherein the thickened circumferential region is substantially disposed adjacent to threads on the bottle neck; whereby a compressive load transferred from a capsule top to the capsule portion below the capsule top is further transferred partially to a capsule portion below the thickened circumferential region of the capsule, and partially to the threads on the bottle neck.

39. A container system, comprising: a bottle having a threaded neck; a threaded capsule, said threaded capsule having threads configured to mate with threads on the neck; a thickened annular region disposed at a top of the capsule; a sealing liner disposed within the threaded capsule; wherein the thickened annular region is substantially disposed above a top of the bottle neck; whereby a compressive load placed upon the thickened annular region is transferred partially to a capsule portion below a capsule top, and partially to the sealing liner, and ultimately to the top of the bottle neck.

40. A container system, comprising: a bottle having a threaded neck; a threaded capsule, said threaded capsule having threads configured to mate with threads on the bottle neck; and a thickened circumferential region disposed about sides of the capsule; wherein the thickened circumferential region is substantially disposed adjacent to threads on the bottle neck; whereby a compressive load transferred from a capsule top to the capsule portion below the capsule top is further transferred partially to a capsule portion below the thickened circumferential region of the capsule, and partially to the threads on the bottle neck.

41. A method for sealing a bottle with a threaded neck, said method comprising: rotatably coupling a threaded capsule to said bottle, said capsule comprising: a threaded capsule, said threaded capsule having threads configured to mate with threads on the bottle neck; a thickened annular region disposed at a top of the capsule; and a sealing liner disposed within the threaded capsule; wherein the thickened annular region is substantially disposed above a top of the bottle neck; whereby a compressive load placed upon the thickened annular region is transferred partially to a capsule portion below a capsule top, and partially to the sealing liner, and ultimately to the top of the bottle neck.

42. A method for sealing a bottle with a threaded neck, said method comprising: rotatably coupling a threaded capsule to said bottle, said capsule comprising: a threaded capsule, said threaded capsule having threads configured to mate with at least a portion of the threads on the neck portion; and a thickened circumferential region disposed about the sides of the capsule; wherein the thickened circumferential region is substantially disposed adjacent to threads on the bottle neck; whereby a compressive load transferred from a capsule top to the capsule portion below the capsule top is further transferred partially to a capsule portion below the thickened circumferential region of the capsule, and partially to the threads on the bottle neck.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for sealing a container, comprising:
a threaded capsule; and
means associated with said capsule for sealing a liquid within a container of the type having an opening with threads adjacent the opening.

2. An apparatus as recited in claim 1, wherein said capsule comprises a plastic material selected from a group of plastic materials consisting essentially of: polyethylene (PE) of all densities (LDPE to HDPE), polyethylene terephthalate (PET), recycled polyethylene terephthalate, cross-linked polyethylene (PET), polyphenyl ether (PPE), polyvinyl chloride (PVC), polyvinylidene chloride (PVDC), polylactic acid (PLA), polypropylene (PP), polybutylene (PB), polybutylene terephthalate (PBT), polyamide (PA), polyimide (PI), polycarbonate (PC), polytetrafluoroethylene (PTFE), polystyrene (PS), polyurethane (PU), polyester (PEs), acrylonitrile butadiene styrene (ABS), polymethyl methacrylate (PMMA), polyoxymethylene (POM), polysulfone (PES), styrene-acrylonitrile (SAN), ethylene vinyl acetate (EVA), styrene maleic anhydride (SMA), one or more of the foregoing, and glass or other insoluble structural fiber fillings mixed within the foregoing.

3. An apparatus as recited in claim 1, wherein said capsule comprises a threaded sleeve portion with an unthreaded top portion, or an unthreaded sleeve portion with a threaded top portion, or a threaded sleeve portion with a threaded top portion.

4. An apparatus as recited in claim 3, wherein the sleeve portion and top portion are a unitary member.

5. An apparatus as recited in claim 3, wherein the sleeve portion and top portion comprise separate sleeve and top members attached to each other.

6. An apparatus as recited in claim 3, wherein said threads are integrated into the sleeve or top portions.

7. An apparatus as recited in claim 3, wherein said threads comprise one or more separate threaded inserts.

8. An apparatus as recited in claim 1:
wherein said container has a top portion and a rim adjacent the top portion;
wherein said capsule has a top portion with an underside;
wherein said means for sealing comprises a liner in said capsule; and
wherein when said capsule is on the container and in a sealed position, the liner is disposed between the underside of the top portion of said capsule and the rim at the top of the container.

9. An apparatus as recited in claim 8, wherein said capsule includes a “breakaway” or “separation” line.

10. An apparatus as recited in claim 1:
wherein said container has an opening and a land disposed about the opening;
wherein said capsule has a sleeve portion and a top portion;
wherein said means for sealing comprises a plurality of closure tabs of three or more heights on the sleeve portion of said capsule that are configured to clasp the land on the container; and
wherein said capsule includes a separation line for separation of the top portion of said capsule from the sleeve portion of said capsule.

11. An apparatus as recited in claim 1, wherein said means for sealing comprises:
a thickened annular or circumferential region in the capsule, or both, that compresses against the container to form a seal.

12. An apparatus as recited in claim 1, wherein said means for sealing comprises a multi-layer sealing liner comprising some or all of a liquid-sealing layer, a resilient compressible layer, and an oxygen-transfer-rate (OTR) controlling layer, wherein the OTR-controlling layer comprises an oxygen-blocking means with a window comprising oxygen transfer means consisting of a material with specifiable oxygen transfer rate higher than that of the oxygen-blocking means.

13. A container system, comprising:
a container having a neck portion with threads positioned along the neck portion;
a threaded capsule, said threaded capsule having threads configured to mate with at least a portion of the threads on the container; and
means associated with said capsule for sealing a liquid within the container.

14. A system as recited in claim 13, wherein said capsule comprises a plastic material selected from a group of plastic materials consisting essentially of: polyethylene (PE) of all densities (LDPE to HDPE), polyethylene terephthalate (PET), recycled polyethylene terephthalate, cross-linked polyethylene (PET), polyphenyl ether (PPE), polyvinyl chloride (PVC), polyvinylidene chloride (PVDC), polylactic acid (PLA), polypropylene (PP), polybutylene (PB), polybutylene terephthalate (PBT), polyamide (PA), polyimide (PI), polycarbonate (PC), polytetrafluoroethylene (PTFE), polystyrene (PS), polyurethane (PU), polyester (PEs), acrylonitrile butadiene styrene (ABS), polymethyl methacrylate (PMMA), polyoxymethylene (POM), polysulfone (PES), styrene-acrylonitrile (SAN), ethylene vinyl acetate (EVA), styrene maleic anhydride (SMA), one or more of the foregoing, and glass or other insoluble structural fiber fillings mixed within the foregoing.

15. A system as recited in claim 14, wherein said capsule comprises a threaded sleeve portion with an unthreaded top portion, or an unthreaded sleeve portion with a threaded top portion, or a threaded sleeve portion with a threaded top portion.

16. A system as recited in claim 15, wherein the sleeve portion and top portion are a unitary member.

17. A system as recited in claim 15, wherein the sleeve portion and top portion comprise separate sleeve and top members attached to each other.

18. A system as recited in claim 15, wherein said threads are integrated into the sleeve or top portions.

19. A system as recited in claim 15, wherein said threads comprise one or more separate threaded inserts.

20. A system as recited in claim 13:
wherein said container has a top portion and a rim adjacent the top portion;
wherein said capsule has a top portion with an underside;
wherein said means for sealing comprises a liner in said capsule; and
wherein when said capsule is on the container and in a sealed position, the liner is disposed between the underside of the top portion of said capsule and the rim at the top of the container.

21. A system as recited in claim 20, wherein said capsule includes a “breakaway” or “separation” line.

22. A system as recited in claim 13:
wherein said container has an opening and a land disposed about the opening;
wherein said capsule has a sleeve portion and a top portion;
wherein said means for sealing comprises a plurality of closure tabs of three or more heights on the sleeve portion of said capsule that are configured to clasp the land on the container; and
wherein said capsule includes a separation line for separation of the top portion of said capsule from the sleeve portion of said capsule.

23. A system as recited in claim 13, wherein said means for sealing comprises:
a thickened annular or circumferential region in said capsule that compresses against the container to form a seal.

24. A system as recited in claim 13, wherein said means for sealing comprises a multi-layer sealing liner comprising some or all of a liquid-sealing layer, a resilient compressible layer, and an oxygen-transfer-rate (OTR) controlling layer, wherein the OTR-controlling layer comprises an oxygen-blocking means with a window comprising oxygen transfer means consisting of a material with specifiable oxygen transfer rate higher than that of the oxygen-blocking means.

25. A method for sealing a container of the type having a neck portion with threads positioned along the neck portion, said method comprising:
rotatably coupling a threaded capsule to said container, said capsule comprising:
a threaded capsule, said threaded capsule having threads configured to mate with at least a portion of the threads on the container; and
means associated with said capsule for sealing a liquid within the container.

26. A method as recited in claim 25, wherein said capsule comprises a plastic material selected from a group of plastic materials consisting essentially of: polyethylene (PE) of all densities (LDPE to HDPE), polyethylene terephthalate (PET), recycled polyethylene terephthalate, cross-linked polyethylene (PET), polyphenyl ether (PPE), polyvinyl chloride (PVC), polyvinylidene chloride (PVDC), polylactic acid (PLA), polypropylene (PP), polybutylene (PB), polybutylene terephthalate (PBT), polyamide (PA), polyimide (PI), polycarbonate (PC), polytetrafluoroethylene (PTFE), polystyrene (PS), polyurethane (PU), polyester (PEs), acrylonitrile butadiene styrene (ABS), polymethyl methacrylate (PMMA), polyoxymethylene (POM), polysulfone (PES), styrene-acrylonitrile (SAN), ethylene vinyl acetate (EVA), styrene maleic anhydride (SMA), one or more of the foregoing, and glass or other insoluble structural fiber fillings mixed within the foregoing.

27. A method as recited in claim 26, wherein said capsule comprises a threaded sleeve portion with an unthreaded top portion, or an unthreaded sleeve portion with a threaded top portion, or a threaded sleeve portion with a threaded top portion.

28. A method as recited in claim 27, wherein the sleeve portion and top portion are a unitary member.

29. A method as recited in claim 27, wherein the sleeve portion and top portion comprise separate sleeve and top members attached to each other.

30. A method as recited in claim 27, wherein threads are integrated into at least one of the threaded portions.

31. A method as recited in claim 27, wherein a threaded insert is coupled to at one of the threaded portions.

32. A method as recited in claim 25:
wherein said container has a top portion and a rim adjacent the top portion;
wherein said capsule has a top portion with an underside;
wherein said means for sealing comprises a liner in said capsule; and
wherein when said capsule is on the container and in a sealed position, the liner is disposed between the underside of the top portion of said capsule and the rim at the top of the container.

33. A method as recited in claim 32, wherein said capsule includes a “breakaway” or “separation” line.

34. A method as recited in claim 25:
wherein said container has an opening and a land disposed about the opening;
wherein said capsule has a sleeve portion and a top portion;
wherein said means for sealing comprises a plurality of closure tabs of three or more heights on the sleeve portion of said capsule that are configured to clasp the land on the container; and
wherein said capsule includes a separation line for separation of the top portion of said capsule from the sleeve portion of said capsule.

35. A method as recited in claim 25, wherein said means for sealing comprises:
a thickened annular or circumferential region in said capsule, or both, that compresses against the container to form a seal.

36. A method as recited in claim 25, wherein said means for sealing comprises a multi-layer sealing liner comprising some or all of a liquid-sealing layer, a resilient compressible layer, and an oxygen-transfer-rate (OTR) controlling layer, wherein the OTR-controlling layer comprises an oxygen-blocking means with a window comprising oxygen transfer means consisting of a material with specifiable oxygen transfer rate higher than that of the oxygen-blocking means.

37. An apparatus for sealing a bottle having a neck, comprising:
a threaded capsule;
a thickened annular region disposed at a top of the capsule;
a sealing liner disposed within the threaded capsule;
wherein the thickened annular region is substantially disposed above a top of the bottle neck;
whereby a compressive load placed upon the thickened annular region is transferred partially to a capsule portion below a capsule top, and partially to the sealing liner, and ultimately to the top of the bottle neck.

38. An apparatus for sealing a bottle with a threaded neck, comprising:
a threaded capsule;
a thickened circumferential region disposed about the sides of the capsule;
wherein the thickened circumferential region is substantially disposed adjacent to threads on the bottle neck;
whereby a compressive load transferred from a capsule top to the capsule portion below the capsule top is further transferred partially to a capsule portion below the thickened circumferential region of the capsule, and partially to the threads on the bottle neck.

39. A container system, comprising:
a bottle having a threaded neck;
a threaded capsule, said threaded capsule having threads configured to mate with threads on the neck; and
a thickened annular region disposed at a top of the capsule;
a sealing liner disposed within the threaded capsule;
wherein the thickened annular region is substantially disposed above a top of the bottle neck;
whereby a compressive load placed upon the thickened annular region is transferred partially to a capsule portion below a capsule top, and partially to the sealing liner, and ultimately to the top of the bottle neck.

40. A container system, comprising:
a bottle having a threaded neck;
a threaded capsule, said threaded capsule having threads configured to mate with threads on the bottle neck; and
a thickened circumferential region disposed about sides of the capsule;
wherein the thickened circumferential region is substantially disposed adjacent to threads on the bottle neck;
whereby a compressive load transferred from a capsule top to the capsule portion below the capsule top is further transferred partially to a capsule portion below the thickened circumferential region of the capsule, and partially to the threads on the bottle neck.

41. A method for sealing a bottle with a threaded neck, said method comprising:
rotatably coupling a threaded capsule to said bottle, said capsule comprising:
a threaded capsule, said threaded capsule having threads configured to mate with threads on the bottle neck;
a thickened annular region disposed at a top of the capsule; and
a sealing liner disposed within the threaded capsule;
wherein the thickened annular region is substantially disposed above a top of the bottle neck;
whereby a compressive load placed upon the thickened annular region is transferred partially to a capsule portion below a capsule top, and partially to the sealing liner, and ultimately to the top of the bottle neck.

42. A method for sealing a bottle with a threaded neck, said method comprising:
rotatably coupling a threaded capsule to said bottle, said capsule comprising:
a threaded capsule, said threaded capsule having threads configured to mate with at least a portion of the threads on the neck portion; and
a thickened circumferential region disposed about the sides of the capsule;
wherein the thickened circumferential region is substantially disposed adjacent to threads on the bottle neck;
whereby a compressive load transferred from a capsule top to the capsule portion below the capsule top is further transferred partially to a capsule portion below the thickened circumferential region of the capsule, and partially to the threads on the bottle neck.
